(19) United States
(12) Patent Application Publication
(10) Pub. No.: US 2016/0342271 A1
(43) Pub. Date: Nov. 24, 2016

(54) Touch Screen and Method for Manufacturing the Same

(71) Applicant: SHENZHEN CHINA STAR OPTOELECTRONICS TECHNOLOGY CO., LTD., Shenzhen, Guangdong (CN)

(72) Inventors: Xingling GUO, Shenzhen, Guangdong (CN); Yao-li HUANG, Shenzhen, Guangdong (CN); Man LI, Shenzhen, Guangdong (CN)

(73) Assignee: Shenzhen China Star Optoelectronics Technology Co., Ltd., Shenzhen, Guangdong (CN)

(21) Appl. No.: 14/422,670

(22) PCT Filed: Jan. 5, 2015
(86) PCT No.: PCT/CN2015/070118

§ 371 Date: Feb. 19, 2015

(30) Foreign Application Priority Data
Dec. 11, 2014 (CN) 201410765254.2

(51) Int. Cl. G06F 3/041; G02F 1/1368; G02F 1/1343; G02F 1/1333

(52) U.S. Cl. CPC G06F 3/0418; G06F 3/0412; G02F 1/13338; G02F 1/1368; G02F 1/134309; G02F 1/13439; G06F 2203/04103; G02F 2001/133302; G02F 2201/50

(57) ABSTRACT

The disclosure is related to a touch screen comprising a liquid crystal display layer, a touch sensing layer and a panel protection layer, stacked sequentially from bottom to top. The touch sensing layer comprises a filter glass layer, a touch circuitry and an intermediate glass layer. The touch circuitry comprises a sensing circuit layer and a driving circuit layer respectively formed on the two opposite surfaces of the intermediate glass layer. The disclosure is further related to a method for manufacturing the above touch screen. Light and thin touch screens are achieved by way of configuring the sensing circuit layer and a driving circuit layer of the touch circuitry respectively on the two opposite surfaces of the intermediate glass layer.

### BACKGROUND OF THE INVENTION

1. Field of the Invention

The disclosure is related to screen design and manufacture field, and more particular to a touch screen and method for manufacturing the same.

2. The Related Arts

The intense competence on the market for touch display products is deepening increasingly. Light and thin configuration design for mobile phones, tablet, computers and other electronic products currently has become focus that the manufactures concern about. One important means to achieve light and thin display screen is adoption of the full lamination technology, which is used to replace the edge lamination technology which is an original and simple approach to secure the four sides of the touch screen and the display screen using double-sided adhesives.

The full lamination technology comprises One Glass Solution (OGS) technology led by touch screen manufactures, and On-Cell and In-Cell technology led by display screen manufactures. The One Glass Solution technology forms the ITO conductive films and sensors directly on the protection glass. The glass simultaneously has the function of protection and touch sensing. The In-Cell technology indicates that the function of touch panels is embedded into the liquid crystal pixels. The On-Cell technology indicates that the function of touch panels between the color filter substrate and the polarizer.

Compared with the edge lamination technology, the OGS technology and the On-Cell technology may save one piece of glass and once lamination such that the touch screen may be made thinner and the cost is lower. However, the former requires a touch panel layer on the protection glass, and the latter requires a touch panel layer between color filter glass and the polarizer. Therefore, further reduction on the thickness of the display screen is limited. Although the In-Cell technology may achieve the object of being light and thin through making the touch panel in the liquid crystal, because the In-Cell technology forms the touch sensing lines and touch driving lines intersecting with the touch sensing lines on different surfaces directly on the TFT substrate, there are problems of internal noise and yield having affection on the touch performance of the touch screen.

### SUMMARY

In view of the deficiency of the current technology, one embodiment of the disclosure provides a method for manufacturing a touch screen to further achieve light and thin touch screens and to improve the touch performance of the touch screens.

In order to achieve the above objects, the disclosure adopts the following technical solutions.

A touch screen comprises a liquid crystal display layer, a touch sensing layer and a panel protection layer, stacked sequentially from bottom to top. The touch sensing layer comprises a filter glass layer, a touch circuitry and an intermediate glass layer. The touch circuitry comprises a sensing circuit layer and a driving circuit layer respectively formed on the two opposite surfaces of the intermediate glass layer.

In another embodiment, the sensing circuit layer closely contacts with the lower surface of the panel protection layer.

In another embodiment, the sensing circuit layer and the driving circuit layer comprise a plurality of parallel electrode strips, and the electrode strips of the sensing circuit layer are vertical to the electrode strips of the driving circuit layer.

In another embodiment, the touch sensing layer is formed from Tin-doped indium oxide material.

In another embodiment, the sensing circuit layer is adhesive on the upper surface of the intermediate glass layer by an adhesive layer.

In another embodiment, the liquid crystal display layer comprises a liquid crystal glass layer, a TFT array substrate and a glass substrate, stacked sequentially from top to bottom, and the liquid crystal glass layer closely connects to the lower surface of the filter glass layer.

In another embodiment, the sensing circuit layer is formed on the lower surface of the panel protection layer by etching.

In another embodiment, the driving circuit layer is formed on the upper surface of the filter glass layer by etching.

The disclosure further provides a method for manufacturing the touch screen as stated above, comprising forming the sensing circuit layer on the lower surface of the panel protection layer by etching; and forming the driving circuit layer on the filter glass layer by etching and making RGB color resistance to make the filter glass layer such that the driving circuit layer is integrally formed on the upper surface of the filter glass layer.

In this disclosure, light and thin touch screens are sheaved by way of configuring the sensing circuit layer and a driving circuit layer of the touch circuitry respectively on the two opposite surfaces of the intermediate glass layer. Meanwhile, the sensing circuit layer is less interfered by the TFT electric field on the TFT array substrate to facilitate increasing the touch performance of the touch screen.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a schematic cross-section view of the touch screen according to the embodiment of the disclosure;

FIG. 2 is a schematic view of the touch screen according to the embodiment of the disclosure; and

FIG. 3 is a flow chart of the method for manufacturing the touch screen according to the embodiment of the disclosure.

### DETAILED DESCRIPTION

In order to understand the objects, technical solutions and the advantages of the disclosure more clearly, the description and explanation are further given in more details in the following with reference to the accompanying drawings. It should be noted that the specific embodiments described hereinafter are merely for explaining the disclosure, and are not intended to limit the disclosure.

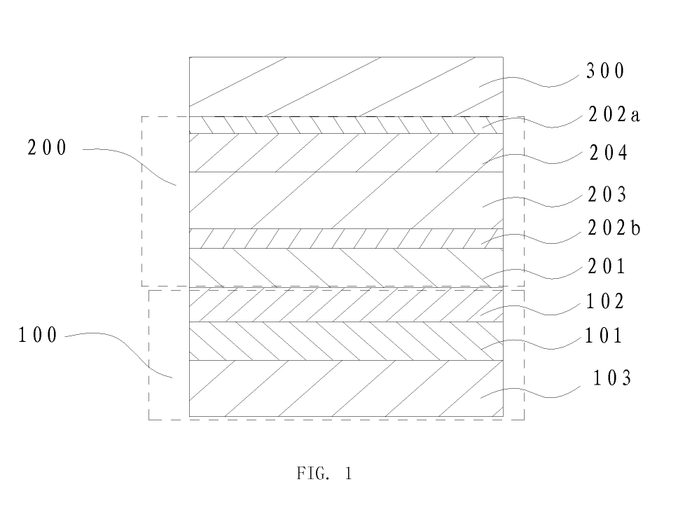

Refer to FIG. 1, the embodiment of the disclosure comprises a liquid crystal display layer 100, a touch sensing layer 200 and a panel protection layer 300, stacked sequentially from bottom to top. The touch sensing layer 200 comprises a filter glass layer 201, a touch circuitry 202 and an intermediate glass layer 203. The touch circuitry 202 comprises a sensing circuit layer 202a and a driving circuit layer 202b respectively formed on the two opposite surfaces of the intermediate glass layer 203.

Specifically, the sensing circuit layer 202a closely contacts with the lower surface of the panel protection layer 300. The sensing circuit layer 202a is adhesive on the upper surface of the intermediate glass layer 203 by an adhesive layer 204. Herein, the adhesive layer 204 is optically clear adhesive (OCA) or liquid transparent optical adhesive (OCR).

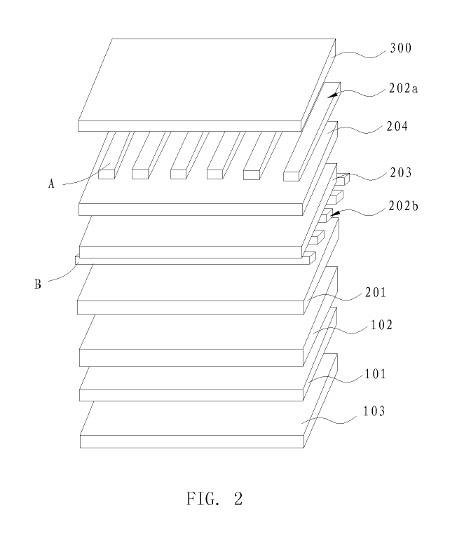

In combination with FIG. 2, the sensing circuit layer 202a and the driving circuit layer 202b respectively comprise a plurality of parallel first electrode strips A and second electrode strips B. The first electrode strips A of the sensing circuit layer 202a are vertical to the electrode strips B of the driving circuit layer 202b. The first electrode strips A and the second electrode strips B of the touch sensing layer 200 are made from transparent Tin-doped indium oxide (ITO) material.

Furthermore, the liquid crystal display layer 100 comprises a liquid crystal glass layer 102, a TFT array substrate 101 and a glass substrate 103, stacked sequentially from top to bottom, and the liquid crystal glass layer 102 closely connects to the lower surface of the filter glass layer 201. The sensing circuit layer 202a is formed on the lower surface of the panel protection layer 300 by etching. The driving circuit layer 202b is formed on the upper surface of the filter glass layer 201 by etching. The driving circuit layer 202b and the filter glass layer 201 are formed integrally. The etching in this embodiment adopts photolithography etching process. The touch panel is formed in such manner that the two conductive electrode layers are respectively formed on the panel protection layer 300 and the filter glass layer 201. Not only the touch panels may be made to be lighter and thinner, but also the sensing circuit layer 202a is more close to the fingers and the reaction of the touch panels are more sensitive because the sensing circuit layer 202a is formed below the panel protection layer. The distance between the sensing circuit layer 202a and the TFT array substrate 300 is farther. Therefore, the sensing circuit layer 202a is less interfered by the TFT electric field on the TFT array substrate 101. The reliability of touch operation is thus increased.

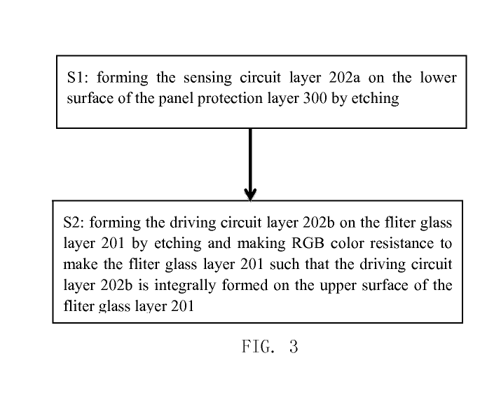

As show in FIG. 3, the method for manufacturing the touch screen as stated above comprises step S1: forming the sensing circuit layer 202a on the lower surface of the panel protection layer 300 by etching; and step S2: forming the driving circuit layer 202b on the filter glass layer 201 by etching and making RGB color resistance to make the filter glass layer 201 such that the driving circuit layer 202b is integrally formed on the upper surface of the filter glass layer 201. In the meanwhile, the manufacturing method further comprises adhering the driving circuit layer 202b on the upper surface of the intermediate glass layer 203; adhering the lower surface of the intermediate glass layer 203 on the upper surface of the filter glass layer 201 having the driving circuit layer 202b by way of machining or OCA or OCR adhesive; and sequentially stacking the liquid crystal glass layer 102, the TFT array substrate 101 and a glass substrate 103 on the lower surface of the filter glass layer 201.

In the present disclosure, the touch panel of the current technology is formed by way of respectively forming the two conductive electrode layers on the panel protection layer 300 and the filter glass layer 201. Thus the touch screen is further made to be lighter and thinner, and the manufacture process is simplified. In the meanwhile, because the sensing circuit layer 202a is formed on the lower surface of the panel protection layer 300, comparing with the original design, the sensing circuit layer 202a is more close to the fingers and the reaction of the touch panel is more sensitive. Further, comparing with the current technology, the sensing circuit layer 202a is less interfered by the TFT electric field on the TFT array substrate 101. The touch performance is thus increased.

The above descriptions are the specific embodiments of the present application. It should be noted that for those skilled in the art variations and modifications might be conducted without departing from the principle of the present application. Those variations and modifications should be regarded as the protection scope of the present application.

What is claimed is:

1. A touch screen, comprising:
a liquid crystal display layer, a touch sensing layer and a panel protection layer stacked sequentially from bottom to top;
wherein the touch sensing layer comprises a filter glass layer, a touch circuitry and an intermediate glass layer;
wherein the touch circuitry comprises a sensing circuit layer and a driving circuit layer respectively formed on the two opposite surfaces of the intermediate glass layer.

2. The touch screen according to claim 1, wherein the sensing circuit layer closely contacts with the lower surface of the panel protection layer.

3. The touch screen according to claim 2, wherein the sensing circuit layer and the driving circuit layer comprise a plurality of parallel electrode strips, and the electrode strips of the sensing circuit layer are vertical to the electrode strips of the driving circuit layer.

4. The touch screen according to claim 4, wherein the touch sensing layer is formed from Tin-doped indium oxide material.

5. The touch screen according to claim 1, wherein the sensing circuit layer is adhesive on the upper surface of the intermediate glass layer by an adhesive layer.

6. The touch screen according to claim 5, wherein the liquid crystal display layer comprises a liquid crystal glass layer, a TFT array substrate and a glass substrate, stacked sequentially from top to bottom, and the liquid crystal glass layer closely connects to the lower surface of the filter glass layer.

7. The touch screen according to claim 5, wherein the sensing circuit layer is formed on the lower surface of the panel protection layer by etching.

8. The touch screen according to claim 5, wherein the driving circuit layer is formed on the upper surface of the filter glass layer by etching.

9. The touch screen according to claim 2, wherein the sensing circuit layer is adhesive on the upper surface of the intermediate glass layer by an adhesive layer.

10. The touch screen according to claim 9, wherein the liquid crystal display layer comprises a liquid crystal glass layer, a TFT array substrate and a glass substrate, stacked sequentially from top to bottom, and the liquid crystal glass layer closely connects to the lower surface of the filter glass layer.

11. The touch screen according to claim 9, wherein the sensing circuit layer is formed on the lower surface of the panel protection layer by etching.

12. The touch screen according to claim 9, wherein the driving circuit layer is formed on the upper surface of the filter glass layer by etching.

13. The touch screen according to claim 3, wherein the sensing circuit layer is adhesive on the upper surface of the intermediate glass layer by an adhesive layer.

14. The touch screen according to claim 13, wherein the liquid crystal display layer comprises a liquid crystal glass layer, a TFT array substrate and a glass substrate, stacked sequentially from top to bottom, and the liquid crystal glass layer closely connects to the lower surface of the filter glass layer.

15. The touch screen according to claim 13, wherein the sensing circuit layer is formed on the lower surface of the panel protection layer by etching.

16. The touch screen according to claim 13, wherein the driving circuit layer is formed on the upper surface of the filter glass layer by etching.

17. A method for manufacturing the touch screen according to claim 1, comprising:
forming the sensing circuit layer on the lower surface of the panel protection layer by etching; and
forming the driving circuit layer on the filter glass layer by etching and making RGB color resistance to make the filter glass layer such that the driving circuit layer is integrally formed on the upper surface of the filter glass layer.

18. The method according to claim 17, wherein the sensing circuit layer and the driving circuit layer comprise a plurality of parallel electrode strips, the electrode strips of the sensing circuit layer are vertical to the electrode strips of the driving circuit layer.

19. The method according to claim 18, wherein the touch sensing layer is formed from Tin-doped indium oxide material.

20. The method according to claim 19, wherein the sensing circuit layer is adhesive on the upper surface of the intermediate glass layer by an adhesive layer.
